(19) United States
(12) Patent Application Publication
(10) Pub. No.: US 2011/0117533 A1
(43) Pub. Date: May 19, 2011

(54) Mechanical edge video application and learning system

(76) Inventors: Vincent Joseph Mika, Chicago, IL (US); Mary Carmella Mika, Chicago, IL (US)

(21) Appl. No.: 12/590,734

(22) Filed: Nov. 13, 2009

(51) Int. Cl. G09B 5/00; A63F 9/24; A63F 9/18

(52) U.S. Cl. 434/308; 463/9; 273/429

(57) ABSTRACT

Mechanical Edge Application is a videogame and learning program. Identity in the videogame comes with a model with interchangeable parts and an activation code. In order to advance in the videogame, actual mechanical/technical lessons have to be learned and passed. These mechanical science lessons would include knowing actual plane components/systems (boat, car) and physics behind their function. Other lessons included upgrading your characters status by a repairman learning to be a pilot by taking simulated flight lessons. Therefore, the “front end” end of the game is an exciting video game, but continuation and increased scoring and winning opportunities is based on technical science lessons of the components and mechanics of an aircraft (boat, car).

### BACKGROUND OF THE INVENTION

This videogame application and learning system Mechanical Edge (Top Flight/Raceway Racer/Fighter Boat) description is an interactive game and learning tool. It was invented as there were no other videogame applications of this caliber that insure fun along with strong, age appropriate mechanical and technical learning. It allows the challenge and fun of a video game. Rewards and points are based on skill and tests taken. Accompanying collectibles and their description cards allow the game to be shared by others outside of the cyber world and better envisioned and discussed by the players.

### BRIEF SUMMARY OF THE INVENTION

Current videogames do not provide a break from free play for just the sake of learning. This is videogame in addition to play, allows total involvement: growth in knowledge base and learning recognition over an extended period of time. Allowing remote access for more than one player insures competition and promotes learning. It also allows easy access to scientific terms and physical concepts not readily available to the age group (7 to 18), in a non intimidating and self-paced method. This videogame solves the problem of “wasted time” in mindless videogames that plagues parents and caregivers along with the attractiveness and all the features of a commonly played video game by the child. The primary objective of this game is fun along with raising the expectation and sense of accomplishment given by exposure and learning of technical and physical terminology and concepts.

### DETAILED DESCRIPTION OF THE INVENTION

Mechanical Edge Video Application and Learning System includes:
Top Flight/Raceway Racer/Fighter Boat

Below is the description of Top Flight—other mechanical and technical vehicles would be included later.

Top Flight is a video game, a learning tool and a building toy. It is meant to be for 7 and up age group.

The entire system so far consists of a vehicle or aircraft. For this example, an aircraft will be overviewed:

1) Different types of model Aircraft(s) with attachable features like a

2) Glider or Boosters that can join and detach from the main Aircraft.

3) Each piece that can fly independently has a code on the aircraft and (a name a number) that is personalized for each aircraft and auxiliary aircraft purchased (for example, L520, G789). Aircraft have any manner of releasing ammunition—e.g., cannon shooters on the side, guns, and bomb droppers). Each pilot/navigator/driver has his own character and you know the description. Both the pilot and the aircraft come with collectable cards that explain their characteristics (see examples).

4) Video game—once the piece is logged in and active (pieces can be logged in and out during the game when they are on active status).

The player controls—flies the aircraft that they log in. The game can be played with 1 or more players—the players can remote in or be at the same location.

See Part A for further description of the video game portion

5) Gaming control panel modeled after an aircraft dashboard. The player controls any aspect of flying (example, speed, height, pathways).

6) Again, there can be 1 or more players. 1 or more players can fly through the obstacle course or go on their adventures defending against lava throwing rock monsters. Or the aircraft can fight each other and the rock monsters.

7) The action would consist of the following:

At the beginning of the game, you start with money and points. You can start by racing, flying through obstacle course and battling a monster throwing (lava, ammunition, etc) at the aircraft.

Once your aircraft (the pilot/driver/navigator) fall out, the pilot has to go to Inventor/Adventure Land. He has to go through maze/obstacle course where he finds medicine, money, points repairmen or keys. Once you have repairmen you to go to the learning module. In the learning module you learn parts of aircraft/vehicle/boat), how they work, engines work, how they are repaired. You read as much as you can to take a test. Once you (your repairman) has learned and passed, you can fix the aircraft/vehicle/boat. Keys can unlock ammunition or weapons.

A repairmen can also be convert to a flyer if he (the player) takes flying lessons. In your quest in this other world you can go searching with friends for keys, etc. You can even win a new pilot with a character in this world behind secret doors. Tools can also be found. Tools and Weapons can be bought with money as well. Whatever is found can be brought back to the home base.

You can even collect repairmen and have them learn at any time, even when you are not playing. The more learning and knowledge you give repairmen the better prepared you will be when the game is going on.

Money given to the player at the beginning can be used for medicine.

You get points by winning races, obstacle courses and/or stay flying while rock monsters hurl at you. You also get points by beating up droids when going through Inventor/Adventure land.

Stored points can be converted to get your aircraft, ships, boat out of a disabled status.

You can add new planes that are bought at any time. But, your disabled plane will stay in that status until you learn how to fix him and the pilot/driver/navigator has medicine.

The Mechanical Edge Video Application and Learning System (flight and vehicle models, description cards, software application. Learning/testing module will:

1. Promote easy access to scientific (mechanical and physical) terms and concepts not readily available to the age group (7 and up), in a fun, non intimidating and self-paced method.

2. Insures social aspects for a rounded learning experience by including associated collectible models (planes, cars, boats)and description cards.
a. Provides opportunity for remote players that expand the possibilities for competition, planning, learning, and skill.

3. Promotes tactile reinforcement of mechanics by providing model airplane, boat, car parts.
